(19) United States
(12) Patent Application Publication
(10) Pub. No.: US 2013/0019015 A1
(43) Pub. Date: Jan. 17, 2013

(54) Application Resource Manager over a Cloud

(71) Applicants: Murthy V. Devarakonda, Peekskill, NY (US); Nikolai A. Joukov, Thornwood, NY (US); Birgit Pfitzmann, Valhalla, NY (US); Shaya Potter, New York, NY (US)

(72) Inventors: Murthy V. Devarakonda, Peekskill, NY (US); Nikolai A. Joukov, Thornwood, NY (US); Birgit Pfitzmann, Valhalla, NY (US); Shaya Potter, New York, NY (US)

(73) Assignee: INTERNATIONAL BUSINESS MACHINES CORPORATION, Armonk, NY (US)

(21) Appl. No.: 13/180,858

(22) Filed: Jul. 12, 2011

(51) Int. Cl. G06F 15/173

(52) U.S. Cl. 709/226

(57) ABSTRACT

An application resource manager obtains a projection of upcoming demand for an application that runs on a cloud. The cloud includes at least one of an infrastructure as a service cloud and a platform as a service cloud. The application resource manager determines, based on the projection, that resources of the cloud that are devoted to the application need to be one of extended and shrunken. One of extending and shrinking the resources of the cloud that are devoted to the application is carried out in response to the determining.

### FIELD OF THE INVENTION

The present invention relates to the electrical, electronic and computer arts, and, more particularly, to cloud computing and the like.

### BACKGROUND OF THE INVENTION

Infrastructure-as-a-Service (IaaS) and Platform-as-a-Service (PaaS) clouds offer basic capabilities for fast deployment (provisioning) of images, stashing images away while they are not used, and potentially live or quasi-live changes to the resources assigned to images. However, this does not directly apply to the application layer (referred to herein interchangeably as the workload layer), i.e., on the application layer there are still humans needed to watch the utilization and to decide when and how it is possible to extend or shrink the infrastructure for an application. Exceptions are applications that are only deployed for a relatively short time and then completely dismantled like development and test applications. Indeed, these are by far the most common applications currently considered for running on IaaS and PaaS clouds.

Software-as-a-Service (SaaS) clouds work on the application layer, but are built very specifically for certain application types, such as the IBM LotusLive solution (trademark of International Business Machines Corporation, Armonk, N.Y., USA) or those available from Salesforce_dot_com, Inc., of San Francisco, Calif., USA (“_dot_” substituted for “.” to avoid inclusion of browser-executable code).

There are also high-level clouds that require applications to be coded in specific new programming models and languages, such as Amazon Web Services (mark of Amazon Web Services LLC, Seattle, Wash., USA), Microsoft Azure (mark of Microsoft Corporation, Redmond, Wash., USA), and Hadoop (available from the Apache Software Foundation).

### SUMMARY OF THE INVENTION

Principles of the invention provide techniques for an application resource manager over a cloud. In one aspect, an exemplary method includes the step of obtaining, by an application resource manager, a projection of upcoming demand for an application that runs on a cloud. The cloud includes at least one of an infrastructure as a service cloud and a platform as a service cloud. Additional steps include determining, by the application resource manager, based on the projection, that resources of the cloud that are devoted to the application need to be one of extended and shrunken; and carrying out one of extending and shrinking the resources of the cloud that are devoted to the application, in response to the determining step.

In another aspect, an exemplary system includes a cloud; the cloud includes at least one of an infrastructure as a service cloud and a platform as a service cloud. Also included in the system are at least one application that runs on the cloud, and an application resource manager. The application resource manager obtains a projection of upcoming demand for the application; determines, based on the projection, that resources of the cloud that are devoted to the application need to be one of extended and shrunken; and carries out one of extending and shrinking the resources of the cloud that are devoted to the application, in response to the determining.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a computer-readable storage medium (or multiple such media).

Techniques of the present invention can provide substantial beneficial technical effects. For example, one or more embodiments may provide one or more of the following advantages:
shorter setup times when requirements on an application and its underlying IT infrastructure change
greater reliability
avoid wasting power with underutilized processors as the amount of resources can be easily increased and/or decreased

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 is an overview system block diagram, according to an aspect of the invention;

FIG. 5 is a detailed system block diagram, according to an aspect of the invention; and

FIG. 6 presents exemplary components of an application resource manager, according to an aspect of the invention.

### DETAILED DESCRIPTION OF PREFERRED EMBODIMENTS

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

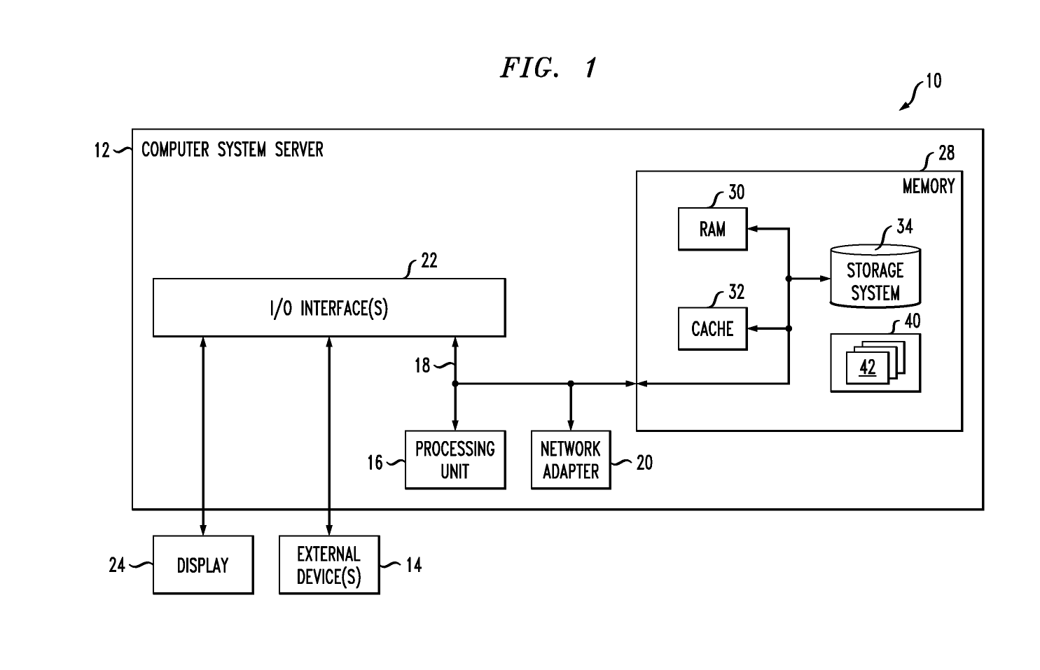

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth herein.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

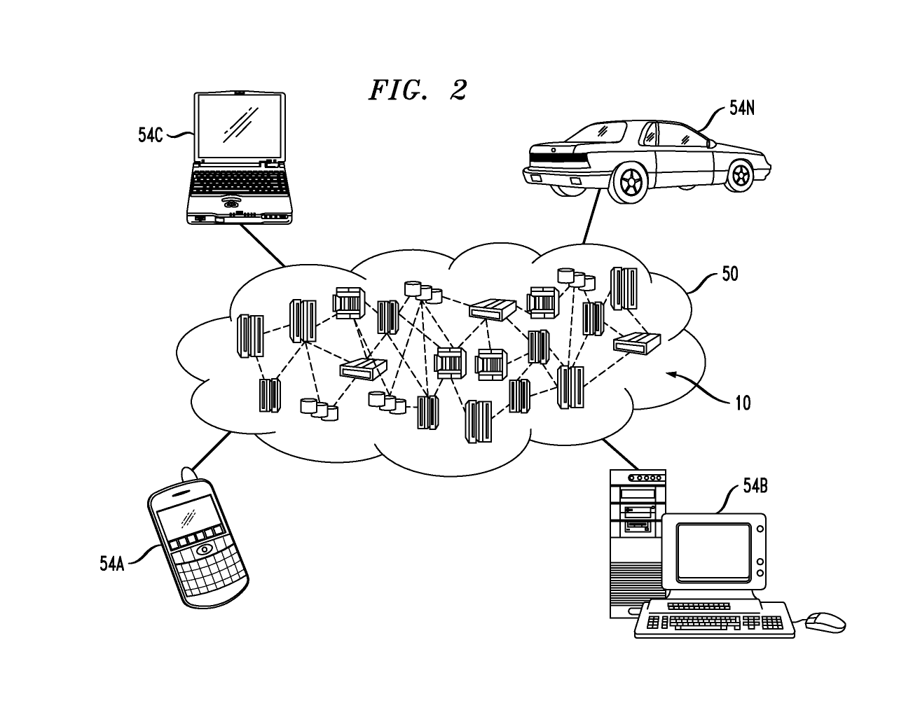

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

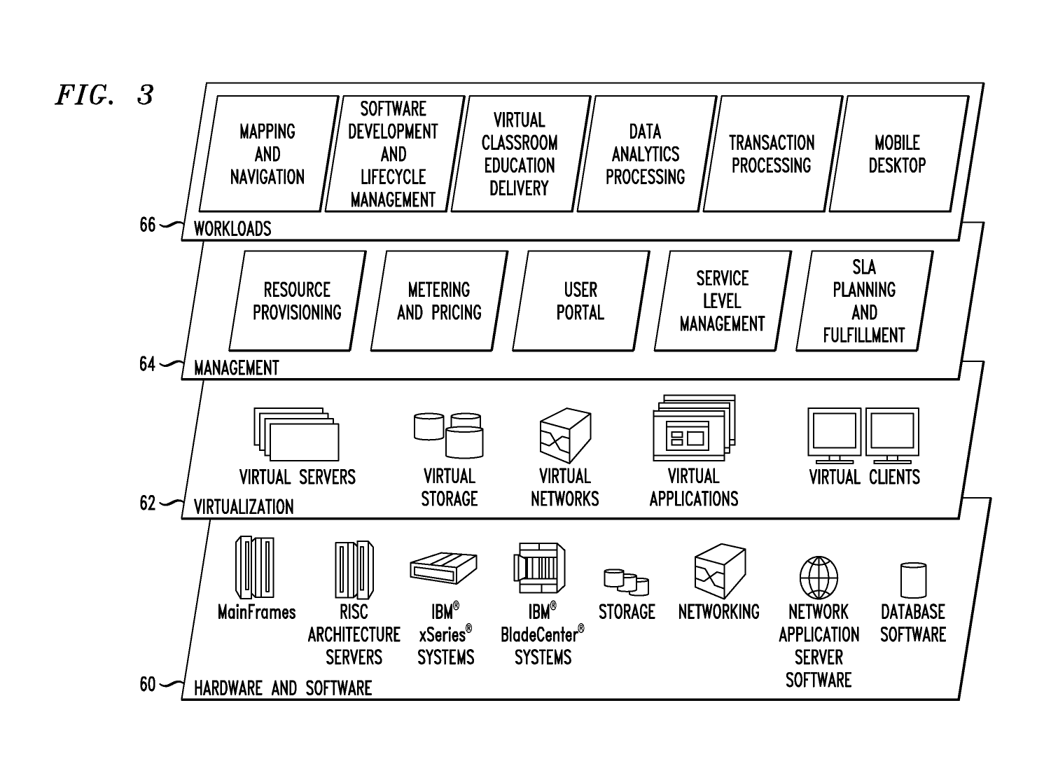

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

One or more embodiments advantageously implement an application resource manager over a cloud, such as, for example, an IaaS or PaaS cloud.

As noted above, Information-as-a-Service (IaaS) and Platform-as-a-Service (PaaS) clouds offer basic capabilities for fast deployment (provisioning) of images, stashing images away while they are not used, and potentially live or quasi-live changes to the resources assigned to images. However, this does not directly apply to the application layer (referred to herein interchangeably as workload layer 66), i.e., on the application layer 66 there are still humans needed to watch the utilization and to decide when and how it is possible to extend or shrink the infrastructure for an application. Exceptions are applications that are only deployed for a relatively short time and then completely dismantled like development and test applications. Indeed, these are by far the most common applications currently considered for running on IaaS and PaaS clouds.

Note that the virtualization and management layers 62 and 64 in IaaS and PaaS clouds manage only the hardware and possibly basic software, while they do not manage the workloads. Accordingly, heretofore this has been done separately and typically with human intervention.

As also noted above, Software-as-a-Service (SaaS) clouds work on the application layer, but are built very specifically for certain application types, such as the IBM LotusLive solution (trademark of International Business Machines Corporation, Armonk, N.Y., USA) or those available from Salesforce_dot_com, Inc., of San Francisco, Calif., USA (“_dot_” substituted for “.” to avoid inclusion of browser-executable code).

Again, as noted above, there are also high-level clouds that require applications to be coded in specific new programming models and languages, such as Amazon Web Services (mark of Amazon Web Services LLC, Seattle, Wash., USA), Microsoft Azure (mark of Microsoft Corporation, Redmond, Wash., USA), and Hadoop (available from the Apache Software Foundation).

One or more embodiments advantageously enable normal, largely unchanged applications with fluctuating or just increasing resource demand to easily make use of IaaS or PaaS platform capabilities.

It is worth noting that there has also been prior work with respect to dynamic infrastructure in the context of grids, but grids do not have the same kind of interfaces for provisioning and managing images as IaaS and PaaS clouds have, and hence the application management problem for grids is different from clouds. Similarly, older large distributed infrastructure projects such as IBM's Oceano computing utility powerplant project did not work with underlying separate layers 60, 62, 64 as in a cloud.

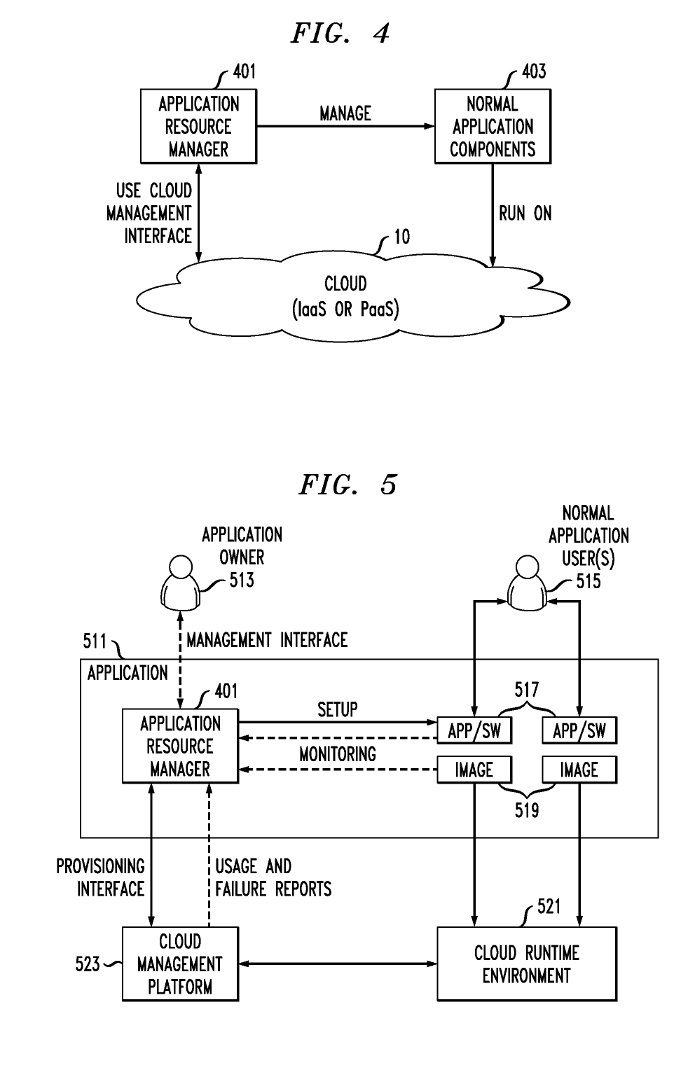

Referring now to the simple system overview of FIG. 4, one or more embodiments employ an application resource manager component 401 that is added to the normal system of IaaS or PaaS cloud 10 and application components 403. This application resource manager extends and shrinks cloud resources according to the application needs.

In order to carry out these tasks, the application resource manager interacts with the management interface of the underlying IaaS or PaaS cloud, i.e., the upper interface of the management layer 64, while the application uses images and other resources provided by the cloud. Here the word “images” is used for both for the pure operating-system images that an IaaS cloud offers and the images including middleware that a PaaS cloud offers. In terms of FIG. 3, IaaS images are virtual servers, and there is typically a catalogue of available, easy to provision images, image files corresponding to this catalogue, and actual instance images that have been provisioned and are running. The resource provisioning component of the management layer 64 offers the catalogue to the potential workloads of layer 66, contains the image files, and causes the establishment of instance images (virtual servers) in the virtualization layer 62. We will sometimes only talk of “images” when this process is understood. On top of the images provisioned to an application, there are the code, data, configurations, and the like of the normal application components. In other words, the part(s) of the workload that were not provisioned via the cloud management layer make up the application components.

The management interfaces that the application resource manager uses may contain OSS aspects (operations support system, e.g., a direct interface to a resource provisioning components) and BSS aspects (business support services, e.g., an interface to the pricing component if additional payment agreement is needed at the time of additional provisioning). All these may be filtered through the user portal, but we assume here that either this also contains an API (application programming interface), web service interface etc. for use by automated programs from the Workloads layer 66, or interfaces to the individual components such as Resource Provisioning are directly accessible to the programs of the Workloads layer 66.

The application resource manager 401 may learn upcoming demand from an application owner 513 (name used herein for a human authorized to predict application demand, to distinguish this role from normal users 515—see FIG. 5), or may derive current utilization and trends from reports obtained from the cloud management as well as by observing the application. The application resource manager 401 may also learn about infrastructure failures, and react on them to reach certain availability targets.

Given demand changes, at a minimum, in at least some embodiments, the application resource manager provisions or stashes images or changes their resource attribution, such as virtual storage or assignment of virtual network bandwidth. Optionally, in the case of provisioning, it also provisions application-level software and/or data onto the new images.

Thus, one or more embodiments provide a system including a cloud 10, at least one application component 403, and an application resource manager 401, wherein the application resource manager extends and/or shrinks cloud resources for the application component in order to meet application resource needs.

The application resource manager, in one or more embodiments, uses the services of an IaaS or PaaS cloud. More details about these components and their interactions are shown in FIG. 5, which provides a more detailed system overview.

It should be noted that the application resource manager 401 may or may not itself run on the cloud 10. The application box 511 is virtual; it indicates that the application resource manager belongs to a specific application and should be aware of the application structure.

With continued reference to FIG. 5, application owner 513 interacts with application resource manager 401 via the application management interface (In FIG. 3 this is the upper interface of the Workloads layer 66, i.e., where the applications/workloads interact with their users). Application resource manager 401 is associated with application 511 and carries out setup of application software 517 used by normal application users 515, as well as monitoring of the application software 517 and corresponding images 519. The images become part of cloud runtime environment 521. Block 521 is essentially analogous to the virtualization layer 62 from FIG. 3 (or layers 60 and 62 together), while cloud management platform 523 is analogous to layer 64. Cloud management platform 523 manages cloud runtime environment 521 which interacts with application resource manager 401 via a suitable provisioning interface (i.e., an interface to the resource provisioning component, either directly or intermediated through a BSS interface and/or the user portal), and cloud management platform 523 also provides usage and failure reports to application resource manager 401 (these could come, e.g., from the metering component or the Service Level Management component of FIG. 3).

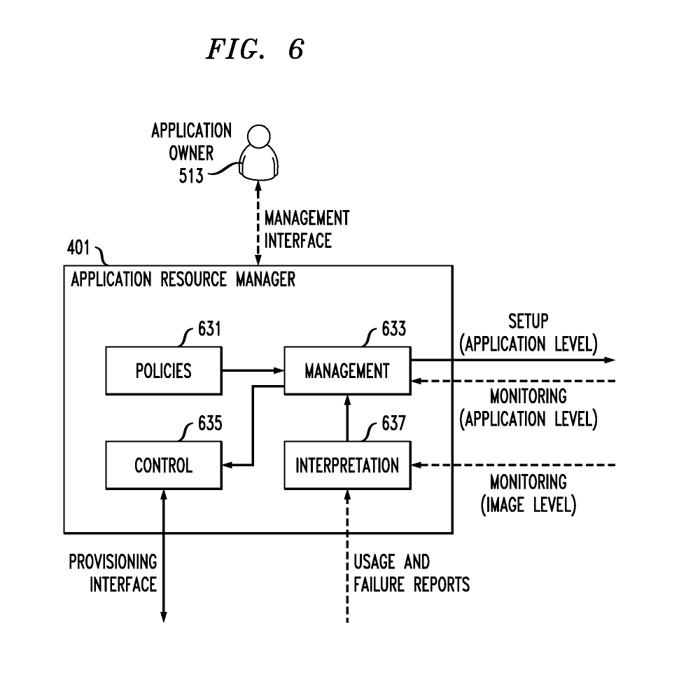

In one or more embodiments, an application resource manager such as 401 may be structured as shown in FIG. 6, wherein the components provide the following exemplary functions:

Policies 631 determine long-term goals, e.g., performance and availability goals that might be given as service-level objectives of the application (in contrast to those of the cloud); in other words these are objectives for Layer 66, not for Layer 64 as the Service Level Management component and SLA planning component of that layer fulfill). Shorter-term objectives from an application owner, such as those relating to a near-term prediction for increased performance needs, may also be phrased as policies.

Management component 633 takes the policies as well as what it learns from the application and the cloud and determines actions. These actions in particular include provisioning, stashing, or de-provisioning requests to the cloud, and whatever other actions the cloud management platform allows, e.g., growing and shrinking of image resources, live migration to different servers, or selection of a higher service level from the cloud (which may, e.g., include better performance guarantees as well as higher availability or reliability guarantees).

The control component 635 translates abstract requests from the management component into concrete interactions with the cloud management platform, e.g., via an application programming interface (API) or a web services interface. Such an interaction may be a multi-step sequence, and might include OSS and BSS level steps, such as choosing an image size and selecting a payment method or existing account number.

The interpretation component 637, conversely to the control component, interprets reports from the cloud, such as utilization information about both the application's own images and other virtual resources and the overall cloud, or failure reports.

A benefit of breaking out a control component and an interpretation component from the management component is that the application resource manager becomes easier to adapt to different clouds. In the example in FIG. 6, the application resource manager is allowed to directly interact with the application components, though, because it is specific to this application.

Additional non-limiting exemplary details will now be provided with respect to some possible functions of the application manager.

With respect to monitoring, in some instances, the application manager may monitor the application components 403 and their utilization, either or both at the user interfaces of the application (where, e.g., an application service-level agreement (SLA) may apply), and for individual components (such as 517, 519); in particular those deployed on different images. The application manager may also obtain information about the current usage of its cloud images via the cloud interface (i.e., from 523), and/or may obtain information about the current overall usage of the cloud via the cloud interface—this may be interesting to predict the effect of obtaining more resources, if the resources are shared.

Furthermore, also with respect to monitoring, in some instances, the application manager may obtain information about failures of its own images (from 523), and general reliability of the cloud; may use prediction, based on utilization trends, to estimate future demand (e.g., predicting monthly peaks, or predicting an overall slow rise in demand); and/or may, from time to time, revalidate the application structure by discovery tools (discussed further elsewhere herein and referred to interchangeably as “rediscovery”). Those would be applied to the application's images 519 and application software 517, as the users 515 of the application may also have certain rights to make changes. Discovery tools may also help to find application-level performance parameters such as current database sizes.

With respect to goals, in some instances, the application manager may obtain short-term goals, either absolute or relative to current performance, from the application owner. These goals typically refer to the application as a whole (e.g., transaction throughput or response time to end users), rather than to the performance of individual application software components on the individual images. Furthermore, the application manager may obtain high-level goals (long-term policies) from the application owner, e.g., to always provide certain SLAs, or to always have a certain amount of headroom for sudden changes; and/or it may obtain cost goals or limits, e.g., to always choose the cheapest overall set of resources to provide a desired SLA, or to always offer best possible performance but only up to a certain cost limit.

With respect to possible decisions, in some instances, the application manager may decide to extend and/or shrink the resources assigned to individual cloud images assigned to the application. Depending on the cloud this might be done in place, or by migrating the corresponding application component 517 to a bigger image 519. In addition, the application manager may decide to provision, delete, or stash away entire cloud images for the use of the application. In this case, it also should deploy appropriate application software on them. In this regard, the application manager may retain one or more gold images for this purpose, i.e., dormant images that already contain all repeatable parts of the application; and/or may also use migration tools to deploy software configurations corresponding to the current overall application status.

Furthermore, also with respect to possible decisions, in some instances, the application manager may decide to ask for additional storage and/or network resources, if the cloud offers such choices separately; may decide to alarm the user if it cannot fulfill its current policies or requests; and/or may inform the user of the application-level situation on a regular basis or upon request.

With respect to decision-making, in some instances, the application manager may make decisions by employing an optimizing solver tool, or it may contain the decision-making code directly. It may make decisions based on dynamic cloud costs, if the cloud has a dynamic pricing schema (e.g., lower cost on weekends). Using dynamic cloud costs is particularly useful if the application contains aspects that are not time-critical and can be performed in times of cheaper resources.

It should be noted that policies can, in at least some instances, be implemented by parameters in a data file or the like wherein allowable values and other variables can be specified without having to change the underlying coding; that is, a data structure specifying allowable values or ranges of values.

With regard to policies block 631, in one or more instances, the same determines goals or requirements, or sometimes what should happen in a specific situation. In particular, it may contain policies (i.e., formalized goals or requirements) on the application level, for example, what latency for application-level transactions is acceptable, how close to deadlines one might get with how many long-running jobs still unfulfilled, or how much load to expect, e.g., at month end. It may sometimes also contain infrastructure-level policies, e.g., what amount of free storage should always be available, what level of usage a virtual machine (VM) should be permitted to have for a sustained period of time, and so on.

Management block 633 includes logic which reads the values from the policies 631 and obtains data input about what is happening in the system (say, from a probe or the like at the application level, as well as, the interpretation block 637, from cloud reports or image-level monitoring), and puts policies 631 into action. Examples include determining that VMs should be allocated, stashed or services started on other VMs; determining if a VM's memory and/or CPU allocation should be increased; determining if storage should be increased and/or decreased; and the like.

Control block 635 provides an interface to different architectures; for example, if the cloud were simply vmware, it would interact with a vmrun interface to control the VMs. That is, control module 635 translates instructions from management module 633 so they can be understood by a resource provisioning module (see layer 64 in FIG. 3) or the like which is managing the cloud resources.

With regard to interpretation block 637, the same provides an interface to different cloud architectures; for example, if the cloud were simply VMware, it might interpret performance reports from vmware interfaces; and/or an abstraction to probes able to run inside VMs. In some instances, the cloud may provide CPU utilization of images (see, e.g., metering and pricing in layer 64 in FIG. 3). Management block 633 will advise interpretation block 637 that it needs the CPU utilization of all the images, block 637 will translate this and give the required command to the metering and pricing block, and interpret the cloud-specific results into a common format. In some instances, ARM 401 makes a connection to the images it manages on its own layer, in addition to or in lieu of the cloud interface, e.g., to monitor application-level latency (i.e., how long normal application users 515 have to wait for results) or to learn about the status of long-running applications. In such cases, an IP listening service or web interface for management may be provided by application software 517, and the application manager builds up corresponding connections and sends corresponding management queries.

In some instances, the ARM 401 has an account on the normal image and can use same to log into the normal image and execute a suitable command to read out the CPU utilization directly from the image. In some cases, the application may be programmed to respond to suitable queries, such as how many transactions have been executed in the last 10 minutes.

For the avoidance of doubt, the “application” in this context refers to the code that carries out the ultimate desired function (and has not been provided by the cloud), say, JAVA code within WEBSPHERE software, or a particular database schema within DB2 software, or typically a combination of such types of code, e.g., all code pieces needed to provide a shopping cart application or a travel reporting application. The probes are pieces of software that communicate with other software to obtain desired values, as opposed to physical probes like thermocouples.

By way of a detailed but non-limiting example, consider a three-tier architecture, with a (typically more than one) Web Server, Application Server, and Database. It is desired to keep the average latency for the end-user requests under a specific threshold. Latency can be caused by any of the elements being overloaded. It is desired to measure latency to respond to requests (application specific—example—how long it takes an http server to respond to a request).

In this example, policy block 631 defines what latency should be available for responding to incoming requests and possibly what the regular state of the system should be. Interpretation block 637 interfaces with probes that provide information about individual components. Management block 633, using policy block 631 and data from interpretation bock 637 as well as direct communication with application software, makes decisions, such as to increase the number of VMs handling incoming requests to lower latency if it is too high, possibly deciding which of the 3 tiers is a bottleneck and needs to be increased. Management block 633 interfaces with control block 635 to instruct the cloud to clone an existing master template VM and bring it on-line, and is then responsible for putting appropriate data on it and binding it into the application so that it can take its share of the load.

Conversely, if latency is far below bounds and there are more than the normal steady state number of VMs (per policy 631), management 633 may instruct control 635 to shut down VMs slowly, and it is responsible for resetting the application so that all workload gets handled by the remaining VMs, e.g., by modifying an application-level load balancer policy.

By way of further detail on this non-limiting example, policy 631 defines what latency should be available for responding to incoming requests and what the regular state of the system should be:

```
average_latency {
    period = 1min
    max_latency = 500ms
}
```

This sets a policy that the average latency over a one minute period should not be above 500 ms. Typically, if that were starting to happen, more machines should be allocated. As discussed above, logic in the management module 633 obtains data from the probe, examines the policies 631, and takes appropriate action if any policies are violated; instructions to effectuate same are sent to control block 635 where they are translated as also described above.

Management block 633 can also run micro-tests against each individual application software component 517.

Management block 633 then optionally puts into practice logic to try to determine what layer is causing the latency. It has the ability to perform micro-benchmarks on each layer, which does not impact any other layer. For example, it can fetch a static webpage off the web server to measure just the web server's latency. It can do a simple query against the app server that doesn't hit the database, as well as simple database queries. These enable it to pinpoint which component is overloaded, along with the VM level measurements provided by interpretation block 637, and therefore which component needs to be increased in size. In this regard, note that measurements can be used alone, micro-benchmarks can be used alone, or both can be used together. Furthermore, micro-benchmarks can be based, for example, on a pre-test on a well-running system to know desired values.

If for instance, management block 633 determines that the web server front end is overloaded and the best decision is to add more front ends, it will instruct control block 635 to allocate a new VM, and will then put any necessary additional software and application data on it and integrate it into the application.

If a cloud were just VMware, control block 635 will copy a gold master VM of the web server front end to a new VM. It will then use the VMware API's RegisterVm( ) functionality to add the VM to the VM infrastructure. Once added, control block 635 will use the API to connect to the new VM and use its Start( ) method to boot the machines. Management block 633 will then add it to the cluster of machines handling front end duty. In a simpler example, the size of a machine could be increased.

In another non-limiting example, consider monitoring storage usage. Policy 631 defines what amount of free storage should be available as well as what is too much free storage. Interpretation block 637 interfaces with normal interfaces (du, df, quota, . . . ) to determine the amount of free space. Management block 633 uses both of these pieces of information to determine if not enough free space (or too much) is available. Management block 633 instructs control block 635 to allocate more free space (or reduce) as per policy. A suitable command might be of the form “increase-disk <image id><disk id><size>”.

For example, some VMs might be able to run one or more services, depending on the load of the VM. In some instances, it is then possible to monitor the VM load (from the VM infrastructure), and have probes in each VM to monitor the resource usage (CPU, I/O) of individual services to know how much each individual service is using.

Policy 631 may determine what sustained load a VM should be allowed to operate under and what sustained load the individual services running on the VM should be allowed. Interpretation block 637 interfaces with VM infrastructure load monitoring (overall VM load) and probes inside of VM (to monitor OS level load measurements for each individual service). Management block 633 can make decisions to split apart the VM so that individual services can run on independent VMs if the load on an individual VM is too high or combine them back together if load has decreased. It interfaces with control block 635 to start up new or shut down existing VMs as needed as well as to shut down or start services running on the individual VMs.

In still another non-limiting example, consider growing a VM's memory and CPU usage. Policy 631 determines what sustained memory and CPU load should be allowed on a single machine. Interpretation block 637 obtains reports of CPU usage and free memory and feeds this to management block 633. Management block 633 can decide to increase (or decrease) the CPU and memory allocation of an individual VM. It instructs control block 635 to do so. Control block 635 can shut down the VM (if needed, some VMs support hot-plugging CPUs), reconfigure it to increase the number of CPUs and the allocated memory, and restart it using the VM architecture's interfaces (ex: on vmware, vmrun; and editing the VM's configuration file manually or via APIs).

In an even further non-limiting example, consider a case where a permitted downtime per month is specified. The application manager may keep track of the total downtime thus far during the month; if it notices that the allowable limit is being approached, it will order additional resources using control component 635.

The following are non-limiting exemplary actual commands for provisioning a server and increasing storage:

provision <template/base id name><new id name>>
increase-disk <id name><size>

Given the discussion thus far, it will be appreciated that, in general terms, an exemplary method, according to an aspect of the invention, includes the step of obtaining, by an application resource manager 401, a projection of upcoming demand for an application 403, 511 that runs on a cloud 10. The cloud is an infrastructure as a service cloud and/or a platform as a service cloud. An additional step includes determining, by the application resource manager 401, based on the projection, that resources of the cloud 10 that are devoted to the application need to be extended or shrunken. A further step includes carrying out (or at least specifying how to carry out) extending or shrinking of the resources of the cloud that are devoted to the application, as the case may be, in response to the determining step.

The projection of upcoming demand could be obtained, for example, from application owner 513. In other instances, the projection of upcoming demand could be obtained by the application resource manager 401 itself deriving the projection based on observations of the application 403, 511 and data from a cloud management interface of the cloud 10.

Where it is determined that the resources of the cloud that are devoted to the application need to be shrunken, application resource manager 401 may stash unused images in the cloud. In this regard, it should be noted that such images might not be totally unused at the moment of the decision. For example, there might be a cluster of five images, and each is currently only 50% used, so it is decided to reduce to four or even three. At the moment of stashing, the images in question should indeed be unused, in the sense that the requests to it/them are now directed elsewhere. For example, in the case of a load balancer used for a given cluster, the application resource manager 401 would change the policy of the load balancer such that requests are now sent only to the (application component of) the remaining three or four images.

Where it is determined that the resources of the cloud that are devoted to the application need to be extended, application resource manager 401 may provision new images in the cloud. In some cases, this can involve the application resource manager provisioning application level software and/or data onto the new images.

As noted, in some cases, the application resource manager 401 runs on the cloud 10. In other instances, the application resource manager runs on a computing resource other than the cloud.

In some cases, the determining step includes finding the most cost-effective way to fulfill the projected upcoming demand.

It should be noted that the projected upcoming demand may be specified in terms of performance and/or availability.

It should also be noted that in some instances, the application manager sometimes rediscovers the application, i.e., discovers (e.g., with a discovery tool) changes directly made by the server administrator on the application software 517 and/or underlying images 519 (as opposed to changes made using an application manager tool in accordance with one or more embodiments of the invention).

Furthermore, given the discussion thus far, it will be appreciated that, in general terms, an exemplary system, according to an aspect of the invention, includes a cloud 10. The cloud is an infrastructure as a service cloud and/or a platform as a service cloud. Also included are at least one application 403, 511 that runs on the cloud, and an application resource manager 401. The application resource manager 401 obtains a projection of upcoming demand for the application 403, 511; determines, based on the projection, that resources of the cloud 10 that are devoted to the application 403, 511 need to be extended or shrunken; and carries out the extending or shrinking of the resources of the cloud that are devoted to the application, as the case may be, in response to the determining.

The projection of upcoming demand could be obtained, for example, from application owner 513. In other instances, cloud 10 may include a cloud management interface and the application resource manager obtains the projection by deriving the projection based on observations of the application and data from the cloud management interface of the cloud. In this regard, it should be noted that cloud management platform 523 offers the cloud management interface, i.e., a platform contains code and the like but users of the cloud typically can't access the code, only, e.g., a web page where they can see their current images and say “provision one more image for me” or “extend the resources of this image by X.” The web page is the interface, and, in one or more embodiments, it has a programmatic version for programs to make the same inputs.

The resources of the cloud that are devoted to the application may include, for example, images. In some cases, when the application resource manager determines that the resources of the cloud that are devoted to the application need to shrink, the application resource manager carries out the shrinking by stashing unused images.

In some cases, the application resource manager determines that the resources of the cloud that are devoted to the application need to extended, and the application resource manager carries out the extending by provisioning new images in the cloud. As noted, in some cases, this can involve the application resource manager provisioning application level software and/or data onto the new images.

As also noted, the application resource manager may run on the cloud, or on an additional computing resource other than the cloud; such resource also forms part of the system in some instances. It will be appreciated that server 12, although indicated as a cloud resource of cloud 10, is equally representative of a non-cloud computing resource on which the application resource manager 401 could be implemented. Furthermore, an additional computing resource other than the cloud could also include a case where manager 401 runs on a different cloud than the one it manages.

As seen in FIG. 6, the application resource manager, in some cases, in turn includes a management portion 633 and a control portion 635. In such cases, the management portion of the application resource manager can be the component that determines, based on the projection, that the resources of the cloud that are devoted to the application need to be one of extended and shrunken; and the control portion of the application resource manager can be the component that carries out the extending or shrinking the resources of the cloud that are devoted to the application, in response to the determining.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 1, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 1) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, or a scripting language such as Perl. In some instances, an optimizing solver may be used as a subcomponent, e.g., ILOG CPLEX (a high-performance mathematical programming solver for linear programming, mixed integer programming, and quadratic programming, available from International Business Machines Corporation, Armonk, N.Y., USA). In general terms, the program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more embodiments, a significant portion of the code is that associated with the application resource manager; it may run in the cloud or outside. In at least some cases, it is more likely to be on a server than on an end-user machine (if at all, then an end user machine of the application owner), but it is not impossible that the application owner would run it from a laptop or the like.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, an application resource manager module with one or more sub-modules such as a policies sub-module, a management sub-module, a control sub-module, and an interpretation sub-module as illustrated in FIG. 6. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules. In some cases, the determining step is carried out by the management sub-module executing on the at least one hardware processor, and the extending or shrinking is carried out by the control sub-module executing on the at least one hardware processor. The obtaining step may be generally thought of as carried out by the application resource manager module; where the projection is obtained from the application owner, the policy sub-module can be used, while where the application resource manager itself derives the projections from the application and/or data from the cloud management interface, the interpretation sub-module can be employed.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining, by an application resource manager, a projection of upcoming demand for an application that runs on a cloud, said cloud comprising at least one of an infrastructure as a service cloud and a platform as a service cloud;
determining, by said application resource manager, based on said projection, that resources of said cloud that are devoted to said application need to be one of extended and shrunken; and
carrying out one of extending and shrinking said resources of said cloud that are devoted to said application, in response to said determining step.

2. The method of claim 1, wherein said obtaining comprises obtaining said projection from an application owner.

3. The method of claim 1, wherein said obtaining comprises said application resource manager deriving said projection based on observations of at least one of:
said application; and
data from a cloud management interface of said cloud.

4. The method of claim 1, wherein said determining comprises determining that said resources of said cloud that are devoted to said application need to be shrunken, and wherein said carrying out comprises carrying out shrinking by stashing unused images in said cloud.

5. The method of claim 1, wherein said determining comprises determining that said resources of said cloud that are devoted to said application need to be extended, and wherein said carrying out comprises carrying out said extending by provisioning new images in said cloud.

6. The method of claim 5, further comprising said application resource manager provisioning at least one of application level software and data onto said new images.

7. The method of claim 1, further comprising at least one of:
running said application resource manager on said cloud; and
running said application resource manager on a computing resource other than said cloud.

8. The method of claim 1, wherein said determining comprises finding a most cost-effective way to fulfill said projected upcoming demand.

9. The method of claim 1, wherein, in said obtaining step, said projected upcoming demand is specified in terms of at least one of performance and availability.

10. The method of claim 1, further comprising said application resource manager periodically running a discovery tool to detect changes to at least one of:
said application; and
said resources of said cloud that are devoted to said application.

11. The method of claim 1, further comprising providing a system, wherein the system comprises distinct software modules, each of the distinct software modules being embodied on a computer-readable storage medium, and wherein the distinct software modules comprise an application resource manager module, a management sub-module, and a control sub-module;
wherein:
said obtaining is carried out by said application resource manager module executing on at least one hardware processor;
said determining is carried out by said management sub-module executing on said at least one hardware processor; and
said one of extending and shrinking is carried out by said control sub-module executing on said at least one hardware processor.

12. The method of claim 11, wherein:
said distinct software modules further comprise a policies sub-module and an interpretation sub-module;
said determining is carried out by said management sub-module, executing on said at least one hardware processor, implementing at least one policy of said policies sub-module and based on at least one of utilization information and failure reports from said interpretation sub-module.

13. A system comprising:
a cloud, said cloud comprising at least one of an infrastructure as a service cloud and a platform as a service cloud;
at least one application that runs on said cloud; and
an application resource manager;
wherein said application resource manager:
obtains a projection of upcoming demand for said application;
determines, based on said projection, that resources of said cloud that are devoted to said application need to be one of extended and shrunken; and
carries out one of extending and shrinking said resources of said cloud that are devoted to said application, in response to said determining.

14. The system of claim 13, wherein said application resource manager obtains said projection from an application owner.

15. The system of claim 13, wherein said cloud comprises a cloud management interface and wherein said application resource manager obtains said projection by deriving said projection based on observations of said application and data from said cloud management interface of said cloud.

16. The system of claim 13, wherein:
at least some of said resources of said cloud that are devoted to said application comprise images;
said application resource manager determines that said resources of said cloud that are devoted to said application need to shrunken; and
said application resource manager carries out said shrinking by stashing unused ones of said images.

17. The system of claim 13, wherein said application resource manager determines that said resources of said cloud that are devoted to said application need to extended, and wherein said application resource manager carries out said extending by provisioning new images in said cloud.

18. The system of claim 13, wherein:
said application resource manager in turn comprises a management portion and a control portion;
said management portion of said application resource manager determines, based on said projection, that said resources of said cloud that are devoted to said application need to be one of extended and shrunken; and
said control portion of said application resource manager carries out said one of extending and shrinking said resources of said cloud that are devoted to said application, in response to said determining.

19. An application resource manager computer program product comprising a computer readable storage medium having computer readable program code embodied therewith, said computer readable program code comprising:
computer readable program code configured to obtain a projection of upcoming demand for an application that runs on a cloud, said cloud comprising at least one of an infrastructure as a service cloud and a platform as a service cloud;
computer readable program code configured to determine, based on said projection, that resources of said cloud that are devoted to said application need to be one of extended and shrunken; and
computer readable program code configured to specify instructions for carrying out one of extending and shrinking said resources of said cloud that are devoted to said application, in response to said determining.

20. The computer program product of claim 19, wherein said computer readable program code configured to obtain said projection comprises computer readable program code configured to obtain said projection from an application owner.

21. The computer program product of claim 19, wherein said computer readable program code configured to obtain said projection comprises computer readable program code configured to derive said projection based on observations of at least one of:
said application; and
data from a cloud management interface of said cloud.

22. The computer program product of claim 19, wherein said computer readable program code configured to determine comprises computer readable program code configured to determine that said resources of said cloud that are devoted to said application need to be shrunken, and wherein said instructions specify carrying out shrinking by stashing unused images in said cloud.

23. The computer program product of claim 19, wherein said computer readable program code configured to determine comprises computer readable program code configured to determine that said resources of said cloud that are devoted to said application need to be extended, and wherein said instructions specify carrying out said extending by provisioning new images in said cloud.

24. The computer program product of claim 19, wherein said computer readable program code comprises distinct software modules, and wherein the distinct software modules comprise an application resource manager module, a management sub-module, and a control sub-module;
wherein:
said application resource manager module comprises said computer readable program code configured to obtain;
said management sub-module comprises said computer readable program code configured to determine; and
said control sub-module comprises said computer readable program code configured to specify.

25. The computer program product of claim 24, wherein:
said distinct software modules further comprise a policies sub-module and an interpretation sub-module;
said management sub-module carries out said determining by implementing at least one policy of said policies sub-module and based on at least one of utilization information and failure reports from said interpretation sub-module.
